(19) United States
(12) Patent Application Publication
(10) Pub. No.: US 2020/0305400 A1
(43) Pub. Date: Oct. 1, 2020

(54) SNAP ON CLASP FOR FISHING LURE BODY

(71) Applicant: Ric Douglas Britain, JR., Many, LA (US)

(72) Inventor: Ric Douglas Britain, JR., Many, LA (US)

(21) Appl. No.: 16/363,598

(22) Filed: Mar. 25, 2019

(51) Int. Cl. A01K 85/00; A01K 83/00; F16B 2/22; A01K 95/02; A01K 93/00

(52) U.S. Cl. CPC A01K 85/00; A01K 83/00; A01K 93/00; A01K 95/02; F16B 2/22

(57) ABSTRACT

An interchangeable “snap on” fishing lure and clasp. The clasp is molded in the lure body which snaps onto the hook. The clasp configuration saves the plastic lure from damage caused by piercing it with the hook. This greatly improves the life span of the plastic lures. It also makes changing the type or color of one's lure extremely fast and efficient.

### BACKGROUND OF THE INVENTION

The present invention relates to fishing lures, and more particularly to plastic bodied fishing lures.

The manner in which a plastic lure body is mounted on a hook is destructive to the lure body itself, causing the lure to tear, shorting its life span. Plastic fishing lure bodies are prematurely damaged by piercing the lure body when attaching it to the hook. This causes tearing and weakness that greatly shortens the life of the lure. Plastic lures generally only get one use out of them due to the wear and tear of constant casting and water friction.

Current methods of mounting a plastic lure are also time consuming. Particularly, in sport fishing tournaments, changing the color or type of lure so as to attract a fish can also cost the angler valuable time.

As can be seen, there is a need for an apparatus and method for attaching a plastic fishing lure body to a fishing line and hook.

### SUMMARY OF THE INVENTION

In one aspect of the present invention, a snap on clasp for attaching a hook to a fishing lure body is disclosed. The snap on clasp includes a snap retaining element disposed at a forward end of a stem element and a stem insert adapted to be received in an aft end of the stem element in a snap fit configuration, the stem element and stem insert moldable into a head of a plastic fishing lure body.

In some embodiments, the snap retaining element includes a retaining clip defined as an inwardly curled arcuate segment. A first gap is defined between a terminal end of the curled arcuate segment and an interior wall of the snap retaining element. The first gap may be dimensioned to be slightly less than a width of a shank of the hook.

In other embodiments, a pair of laterally opposed retaining clips are provided and a second gap is defined between the arcuate segments of each of the pair of laterally opposed retaining clips. The second gap may be dimensioned to be slightly less than the shank.

In other aspects of the invention a fishing lure is disclosed. The fishing lure includes a snap retaining element disposed at a forward end of a stem element. The snap retaining element is configured to receive a shank of a fish hook. A stem insert is received in an aft end of the stem element, with the aft end of the stem element and the stem insert molded in a head of the fishing lure.

In some embodiments, the snap retaining element includes a retaining clip defined as an inwardly curled arcuate segment, having a first gap defined between a terminal end of the retaining clip and an interior wall of the snap retaining element. The first gap may be dimensioned to be slightly less than a width of the shank of the hook.

In other embodiments, the fishing lure includes a pair of laterally opposed retaining clips; and has a second gap defined between the arcuate segment of each of the pair of laterally opposed retaining clips.

In other embodiments, the second gap is dimensioned to be slightly less than the shank. In some embodiments, the lure includes a weighted stem insert. In other embodiments, the lure includes a buoyant stem insert.

These and other features, aspects and advantages of the present invention will become better understood with reference to the following drawings, description and claims.

### BRIEF DESCRIPTION OF THE DRAWINGS

FIG. 1 is a rear perspective view of the fishing lure clasp;

FIG. 2 is a top view of the fishing lure clasp;

FIG. 3 is a side view of the fishing lure clasp;

FIG. 4 is a front view of the fishing lure clasp;

FIG. 5 is a front perspective view of the stem;

FIG. 6 is an exploded assembly view of the fishing lure clasp and stem;

FIG. 7 is a side view of the fishing lure clasp and stem assembled; and

FIG. 8 is a side view of the fishing lure clasp and plastic worm lure in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide an improved clasp for securing a fish hook to a plastic fishing lure body. The clasp may be molded inside the head plastic lure which snaps onto a shank of the hook. The clasp of the present invention eliminates the need to pierce the head of the plastic lure body in order to mount a hook to the lure. This extends the life of the lure for many more castings. The improved clasp also allows the angler to quickly change out the color or type of lure, saving valuable time and money.

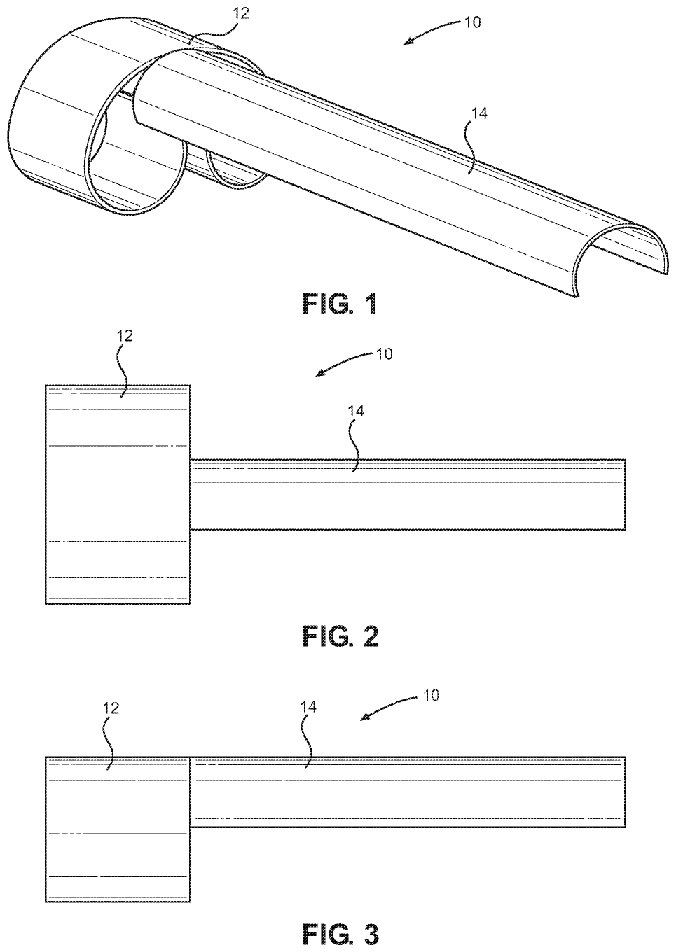

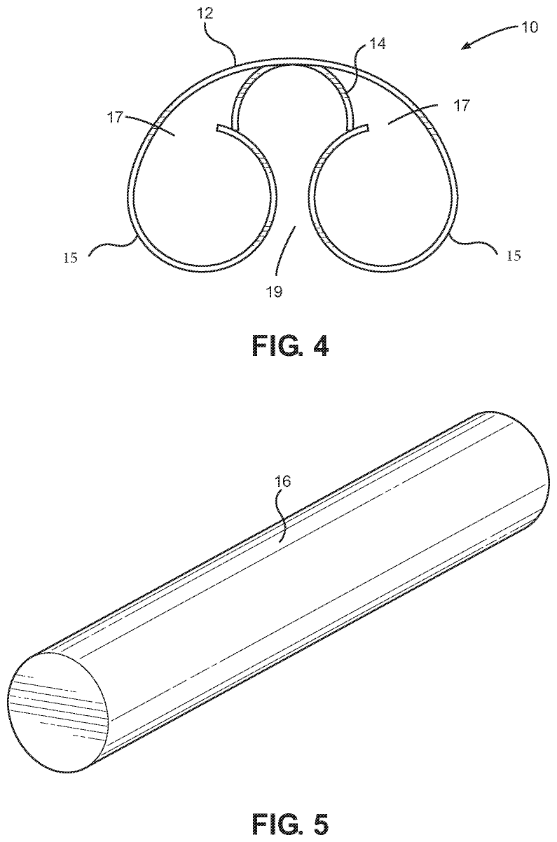

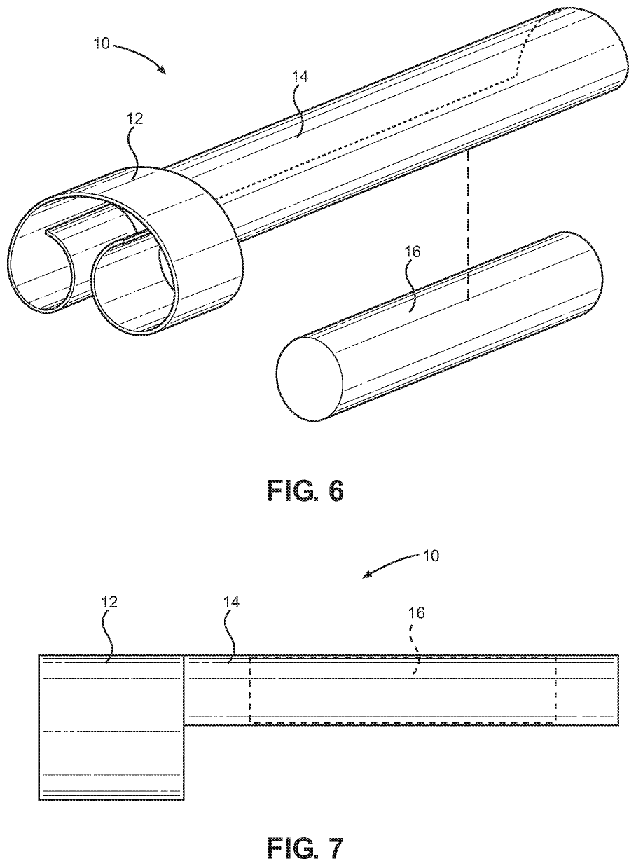

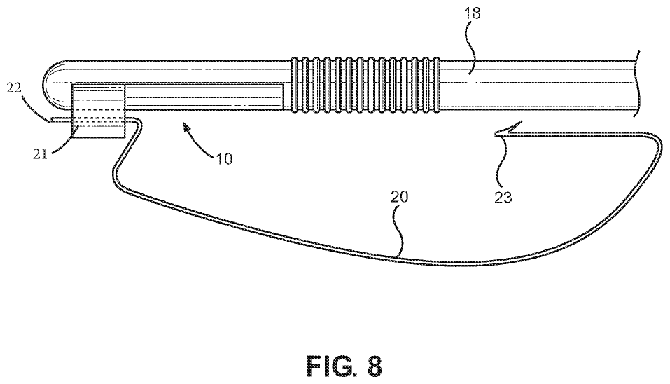

As seen in reference to the drawings of FIGS. 1-8, an improved clasp for a fishing lure is shown. An aft end of the clasp 10 is molded into the head of an artificial fishing lure body 18 to provide a convenient snap fit attachment for mounting a shank of the hook to the head of the lure body 19. The clasp 10 includes a snap retaining element 12 disposed at a forward end of a stem element 14. A stem insert 16 is received in the stem element 14 to provide a reinforcement to the stem element 14.

At least the stem element 14 and stem insert 16 are molded within the head of the plastic lure fishing lure body 18 to provide an attachment of the clasp 10 to the lure body 18. The stem element 14 and stem insert 16 provide an alignment of the clasp 10 with a longitudinal length of the lure body 18. The lure body 18 may be formed in a variety of artificial and natural shapes which may be selected from the group consisting of a worm, a frog, a salamander, a snake, a crayfish, a rodent, and a baitfish.

The snap retaining element 12 includes laterally opposite retaining clips that are formed with an inwardly curling arcuate segment 15. A first gap 17 may be defined between a terminal end of the curled arcuate segment 15 and an interior wall of the snap retaining element 12. The snap retaining element 12 may be formed from a corrosion resistant spring steel, plastic, or a high strength nylon.

Preferably, the first gap 17 is dimensioned to be slightly less than a width of the shank 21 of the hook 20 to facilitate retention of the shank 21, proximal to the eye of the hook 20. Preferably, the shank 21 is offset from the body of the hook 20, such as that shown so that the hook 20 is positioned correctly relative to the lure body 18 when retrieved through the water.

A second gap 19 may also be defined between the arcuate segments 15. The second gap 19 may also be dimensioned to be slightly less than the shank 21. Accordingly, the shank 21 is first received through the second gap 19 and then routed to be received in one of the curling arcuate segments 15. The opposed retaining clips are thereby amenable to use for either left or right handed anglers.

The stem element 14 may be formed in an arch that is dimensioned to receive the stem insert 16 therein. In a preferred embodiment, the arch is slightly greater than a semi-circular segment, such that a cylindrical stem insert 16 may be snap-fit within the stem element 14 so that the pieces can be held together for placement in a mold for forming the plastic lure body 18 about the stem element 14 and insert 16, such as with the injection molding of plastisol. The insert 16 may be a solid or hollow cylindrical member. In some embodiments, the insert 16 may be weighted to facilitate sinking of the lure 18 in a body of water. In other embodiments, the insert 16 may be hollow to add or provide a neutral buoyancy to the lure body 18.

As will be appreciated with the benefit of the present disclosure, the retrieval forces acting on the lure 18 are carried by the clasp 10 and are distributed along the head of the lure 18 by the stem 14 and stem insert 16, thereby reducing the incidence of tearing, whereas in a conventional lure rig the forces are concentrated on the lure 18 at the wire form of the hook 20.

The features of the present invention solve multiple problems of the traditional ways of mounting a plastic fishing lure 18 to a hook 20, which involve threading the hook 20 through the head and out of the body of the lure 18. This causes tearing, stretching and piercing of the plastic lure, during casting, retrieval, and particularly during a strike by a game fish. These methods cause the plastic lure to be weak and unstable on the hook after just a few uses, which causes waste due to the repeated changing of a the weakened plastic lure.

The clasp 10 of the present invention allows the angler to simply attach the plastic lure 18 to the hook 20 by quickly snapping the clasp 10 to the shank 21 of hook 20. This eliminates the need to thread the hook through the head and out of the body of the plastic lure, thereby eliminating a source of damage to the plastic lure 18 caused by the hook 20. The clasp 10 of the present invention greatly enhances the durability and life span of the plastic lure 18. The present invention allows the angler to get many more uses out of a single plastic lure. This, in return, saves the angler many extra expenses.

The clasp 10 of the present invention also allows the angler to quickly interchange plastic lures 18 depending on the size, shape and color desired. The clasp 10 saves valuable time when attaching another plastic lure 18 onto the hook 20. The angler can quickly unsnap the clasp 10 from the hook 20 and simply snap on a new plastic lure 18 with the in molded clasp 10.

It should be understood, of course, that the foregoing relates to exemplary embodiments of the invention and that modifications may be made without departing from the spirit and scope of the invention as set forth in the following claims.

What is claimed is:

1. A snap on clasp for attaching a hook to a fishing lure body, comprising:
a snap retaining element disposed at a forward end of a stem element; and
a stem insert adapted to be received in an aft end of the stem element in a snap fit configuration, the stem element and stem insert moldable into a head of a plastic fishing lure body.

2. The snap on clasp of claim 1, wherein the snap retaining element comprises:
a retaining clip defined as an inwardly curled arcuate segment.

3. The snap on clasp of claim 2, further comprising:
a first gap defined between a terminal end of the curled arcuate segment and an interior wall of the snap retaining element.

4. The snap on clasp of claim 3, wherein the first gap is dimensioned to be slightly less than a width of the shank of the hook.

5. The snap on clasp of claim 4, further comprising:
a pair of laterally opposed retaining clips; and
a second gap defined between the arcuate segment of each of the pair of laterally opposed retaining clips.

6. The snap on clasp of claim 5, wherein the second gap is dimensioned to be slightly less than the shank.

7. A fishing lure, comprising:
a snap retaining element disposed at a forward end of a stem element, the snap retaining element configured to receive a shank of a fish hook; and
a stem insert adapted to be received in an aft end of the stem element, the aft end of the stem element and the stem insert molded in a head of the fishing lure.

8. The fishing lure of claim 7, wherein the snap retaining element comprises:
a retaining clip defined as an inwardly curled arcuate segment, having a first gap defined between a terminal end of the retaining clip and an interior wall of the snap retaining element.

9. The fishing lure of claim 8, wherein the first gap is dimensioned to be slightly less than a width of the shank of the hook.

10. The fishing lure of claim 8, further comprising:
a pair of laterally opposed retaining clips; and
a second gap defined between the arcuate segment of each of the pair of laterally opposed retaining clips.

11. The fishing lure of claim 10, wherein the second gap is dimensioned to be slightly less than the shank.

12. The fishing lure of claim 7, further comprising:
a weighted stem insert.

13. The fishing lure of claim 7, further comprising:
a buoyant stem insert.

14. The fishing lure of claim 7, wherein a body of the lure is selected from the group consisting of a worm, a frog, a salamander, a snake, a crayfish, a rodent, and a baitfish.
